(19) United States
(12) Patent Application Publication
(10) Pub. No.: US 2026/0111770 A1
(43) Pub. Date: Apr. 23, 2026

(54) SYSTEM, EDGE DEVICE, AND CONTROL METHOD THEREOF

(71) Applicant: CANON KABUSHIKI KAISHA, Tokyo (JP)

(72) Inventor: KEI KITAGATA, Kanagawa (JP)

(21) Appl. No.: 19/366,338

(22) Filed: Oct. 22, 2025

(30) Foreign Application Priority Data
Oct. 23, 2024 (JP) 2024-186365

(51) Int. Cl. G06N 5/04

(52) U.S. Cl. CPC G06N 5/04

(57) ABSTRACT

One or more systems, edge devices, control methods, and storage mediums are provided herein. In a case where query data is input from an operation unit of a client terminal or a first edge device, a determining unit of the first edge device determines which of a reasoning unit of the first edge device, a second device, and a first application service should perform a reasoning process on the query data. In a case where it is determined that the second device should perform the reasoning process, the determining unit of the first edge device transmits the query data to the second device without passing through the first application service, and presents to a user answer data received from the second device through the operation unit or the client terminal that is an input source of the query data.

### BACKGROUND

### Field of the Technology

The present disclosure relates to one or more embodiments of a system, an edge device, and a method for controlling the same.

### Description of the Related Art

In recent years, the introduction of Artificial Intelligence (AI) technology into devices has become an important means of increasing the value and competitiveness of devices. The range supported by AI is becoming more diverse. The AI technology contributes to automation, efficiency, and improvement of quality of products using various devices.

Traditionally, the execution of reasoning (inference) processing by AI required sufficient computing resources. As a result, executing the reasoning processing is often limited in remote environments such as cloud services via networks.

However, in addition to the advancement of tuning techniques such as compression and optimization of machine learning models, the performance of information devices is also improved. As a result, executing reasoning processing using the AI technology in a single edge device has become practical. Furthermore, the collaboration between a conventional remote service and a local edge device has also become practical for performing the reasoning processing. For example, performing the reasoning processing on an edge device when responsiveness is sought may be achieved, and performing the reasoning processing using the AI technology in a remote environment when high accuracy and versatility are sought may be achieved.

Japanese Patent Laid-Open No. 2023-507618 discloses executing the reasoning process simultaneously in parallel in a conventional remote environment and in an edge device to obtain ensemble results of these reasoning processes, harmonizing the respective results of the reasoning processes, and providing a result based on the respective results of the reasoning processes having been harmonized.

In a case where there is a device managed by a certain cloud service and the device is caused to cooperate with another device managed by another cloud service, these devices are caused to cooperate with each other between cloud services instead of causing these devices to cooperate with each other directly. The reason for this configuration is that different types of devices can easily cooperate with each other. That is, even after releasing the device, only a small amount of change is required on the device side for cooperation if the cloud service is updated.

However, in the above configuration, cooperating with each other via cloud services takes longer and causes users to wait more time to obtain an answer if a reasoning process is executed for the answer by using a machine learning model of another edge device in which the personality of the user is surely reflected.

### SUMMARY

One or more aspects of the present disclosure provide at least one embodiment of a mechanism in which edge devices each having a reasoning function using artificial intelligence cooperate with each other without deteriorating the performance of a response, thereby efficiently obtaining a result of reasoning.

One aspect according to the present disclosure includes one or more embodiments of a system that may include a plurality of edge devices, each of the plurality of edge devices including: an operating unit that receives operations from a user; a communicating unit that connects the edge device to a network; and a reasoning unit that performs a reasoning process by using a machine learning model for generating answer data as a response to query data, wherein a first edge device of the plurality of edge devices includes: a determining unit that determines which of the reasoning unit, a second edge device, and a service should perform the reasoning process to query data in a case where the query data is input from a client terminal communicable via the network or the operating unit, the second edge device being different from the first edge device, and the service providing a reasoning function via the network for the first edge device; a transmitting unit that transmits the query data to the second edge device without passing through the service in a case where it is determined that the second edge device should perform the reasoning process; and a displaying unit that displays answer data as a response to the query data for the user via the operating unit or the client terminal being a source of the input query data, the query data having been reasoning-processed by the second edge device, and the answer data having been received from the second edge device, wherein the second edge device includes: a reasoning unit that performs the reasoning process for generating answer data as a response to query data in a case where the query data is received from another edge device than the second edge device; and a responding unit that responds to the another edge device with the answer data.

According to other aspects of the present disclosure, one or more additional systems, one or more edge devices, one or more control methods, and one or more storage mediums are discussed herein.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing an example of an overall configuration of at least one embodiment of a reasoning system according to one or more aspects of the present disclosure.

FIG. 2A is a block diagram showing at least one embodiment example of a general hardware configuration of at least a first device and/or a second device that may be used for or with a reasoning system according to one or more aspects of the present disclosure.

FIG. 2B is a block diagram showing at least one embodiment example of a general hardware configuration of a terminal that may be used for or with a reasoning system according to one or more aspects of the present disclosure.

FIG. 2C is a block diagram showing at least one embodiment example of a general hardware configuration of a device management service and a first and/or second application service that may be used for or with a reasoning system according to one or more aspects of the present disclosure.

FIG. 3A is a block diagram showing at least one embodiment example of a software configuration that may be used for a first device and/or a second device of a reasoning system according to one or more aspects of the present disclosure.

FIG. 3B is a block diagram showing at least one embodiment example of a software configuration that may be used for a terminal of a reasoning system according to one or more aspects of the present disclosure.

FIG. 3C is a block diagram showing at least one embodiment example of a software configuration that may be used for a device management service of a reasoning system according to one or more aspects of the present disclosure.

FIG. 3D is a block diagram showing at least one embodiment example of a software configuration that may be used for a first application service and/or a second application service of a reasoning system according to one or more aspects of the present disclosure.

FIG. 4 is a diagram showing a series of one or more embodiments of screens displayed on a display unit of a terminal in a device registration process that may be used for or with a reasoning system according to one or more aspects of the present disclosure.

FIG. 5A shows at least one embodiment example of a sequence for registering a device (e.g., a first device, a second device, etc.) with an application service (e.g., a first application service, a second application service, etc.) that may be used for or with a reasoning system according to one or more aspects of the present disclosure.

FIG. 5B shows at least one embodiment example of a sequence for registering a device (e.g., a first device, a second device, a terminal, etc.) with a device management service that may be used for or with a reasoning system according to one or more aspects of the present disclosure.

FIG. 6A is a diagram showing at least one embodiment example of a screen including a reasoning request and a reasoning result displayed on a display unit of a terminal that may be used for or with a reasoning system according to one or more aspects of the present disclosure.

FIG. 6B is a diagram showing at least one embodiment example of a screen including a reasoning request and a reasoning result displayed on a display unit of a terminal that may be used for or with a reasoning system according to one or more aspects of the present disclosure.

FIG. 7A is a diagram showing at least one embodiment example of a sequence for performing reasoning processing that may be used for or with a reasoning system according to one or more aspects of the present disclosure.

FIG. 7B is a diagram showing at least one embodiment example of a sequence for performing reasoning processing that may be used for or with a reasoning system according to one or more aspects of the present disclosure.

FIG. 7C is a diagram showing at least one embodiment example of a sequence for performing reasoning processing that may be used for or with a reasoning system according to one or more aspects of the present disclosure.

FIG. 8 is a diagram showing at least one embodiment example of a sequence for performing reasoning processing that may be used for or with a reasoning system according to one or more aspects of the present disclosure.

FIG. 9 is a flowchart showing at least one embodiment example of processing for measuring an accuracy value of a reasoning model that may be used for or with a reasoning system according to one or more aspects of the present disclosure.

### DESCRIPTION OF THE EMBODIMENTS

Hereinafter, the embodiments of the present disclosure will be described with reference to the drawings.

### Configuration(s) of One or More Embodiments

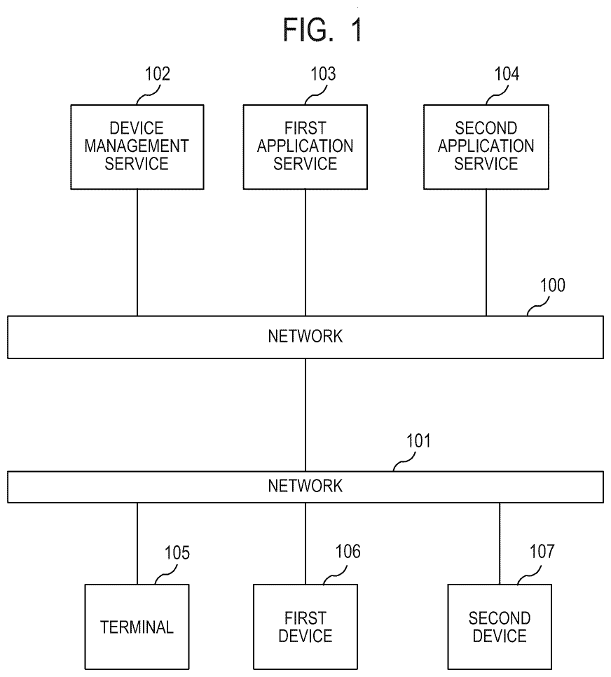

FIG. 1 is a diagram showing an example of an overall configuration of the reasoning system according to one or more embodiments of the present disclosure.

A network 100 and a network 101 are networks for connecting constituent elements of the system. The network 100 and the network 101 are communication networks realized by, for example, a Local Area Network (LAN), a Wide Area Network (WAN), a telephone line, a dedicated digital line, a frame relay line Automatic Teller Machine (ATM), a cable television line, a data broadcasting wireless line, or the like.

A device management service 102, a first application service 103, and a second application service 104 are connected to the network 100. A terminal 105, a first device 106, and a second device 107 are connected to the network 101. The network 100 and the network 101 may be of any type of network as long as data may be transmitted and received (exchangeable) between the constituent elements.

In one or more embodiments, it is assumed that the network 100 is the internet in connection between the device management service 102, the first application service 103, and the second application service 104. In the connection between the first device 106, the second device 107, and the terminal 105, it is assumed that the network 101 is an intranet.

The first device 106 and the second device 107 have a function of connecting to the network 101 and a function of executing reasoning processing using a machine learning model (reasoning processing by Artificial Intelligence (AI)) as a single device.

The first device 106 and the second device 107 may be, for example, home electrical appliances or office machinery. By way of a few examples, the first device 106 and the second device 107 may be a washing machine, an air conditioning product, or a refrigerator as a home electrical appliance, an oven or a microwave oven as a cooking home electrical appliance, or an image forming apparatus as office machinery. The first device 106 and the second device 107 may be a still camera or a video camera as an imaging device. The first device 106 and the second device 107 are apparatuses having a reasoning function in addition to conventional functions. The reasoning function includes, for example, a function of a washing machine for estimating a laundry completion time and a function of an air conditioning product for inferring settings for adjusting the room to an optimal temperature and/or humidity for drying the laundry. The reasoning function also includes, for example, a function of an image forming apparatus for inferring print settings to realize optimal output based on electronic data to be printed and user information. The reasoning function also includes, for example, functions of a camera for inferring optimal shooting settings, and for inferring and analyzing what is the subject being imaged. In at least one embodiment, it is assumed that these devices 106, 107 are home electrical appliances. However, the type of the devices 106, 107 is not limited to the home electric appliance as long as the devices have the network connection function and the function for executing the reasoning process using the machine learning model (reasoning function by artificial intelligence). Hereinafter, an apparatus having a reasoning function may be referred to as a device or an edge device.

In at least one embodiment, the first device 106 and the second device 107 are different types of devices having different functions. Each of the first device 106 and the second device 107 has a network connection function and a function for executing a reasoning process using a machine learning model. FIG. 1 shows only the first device 106 and the second device 107. However, the reasoning system may include other devices having a function of performing reasoning processing than the first and second devices 106, 107.

The terminal 105 has a function of connecting to the network 100 and the network 101. The terminal 105 is a client apparatus connected to the first device 106, the second device 107, and the device management service 102.

In one or more embodiments, the terminal 105 may be, for example, a mobile terminal such as a smartphone, a tablet terminal, or a personal computer (PC). The terminal 105 may be a smart speaker that is a speaker equipped with a network connection function and an AI assistant capable of voice recognition and voice operation. In at least one embodiment, it is assumed that the terminal 105 is a smartphone. However, the terminal 105 is not limited to a specific device as long as the terminal 105 has a network connection function and a user interface function.

The device management service 102 manages information of devices including at least the first and second devices 106, 107. Through an operation by the user, the terminal 105 registers information of the first and second devices 106, 107, and the information of the terminal 105 in the device management service 102. The registration of the information allows a user to instruct the first device 106 and the second device 107 to perform the reasoning process. The first application service 103 and the second application service 104 refer to the registered information to determine whether a reasoning function may be provided to a user's device.

The first application service 103 and the second application service 104 have a function of connecting to the network 100 and a function of independently executing reasoning processing using a machine learning model. Each of the first application service 103 and the second application service 104 is provided corresponding to each device. In at least one embodiment, a service for the first device 106 is the first application service 103, and a service for the second device 107 is the second application service 104. In one or more embodiments, for example, in a case where the reasoning system includes different types of home electrical appliances, e.g., cooking home electrical appliances and air-conditioning home electrical appliances, the reasoning system includes the first application service 103 for the cooking home electrical appliances and the second application service 104 for the air-conditioning home electrical appliances. The functions of the first application service 103 and the second application service 104 are provided to the first device 106 and the second device 107. The first application service 103 and the second application service 104 also provide functions to the terminal 105 that is associated with the first device 106 and the second device 107 in the device management service 102.

In order to simplify descriptions of one or more embodiments, FIG. 1 shows a single component for the respective devices and services. However, each of the devices and services may include two or more devices and services, respectively.

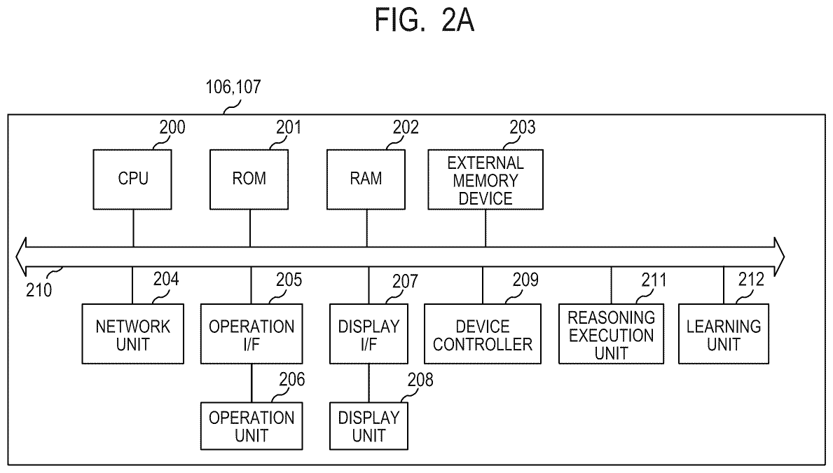

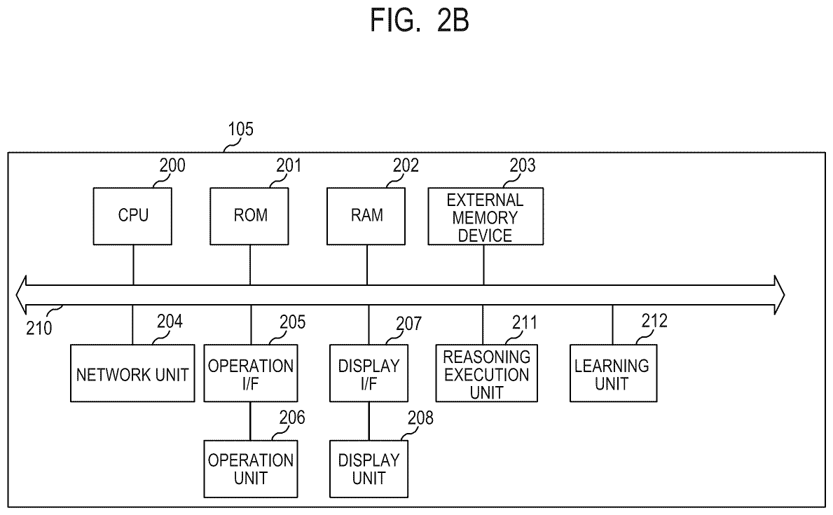

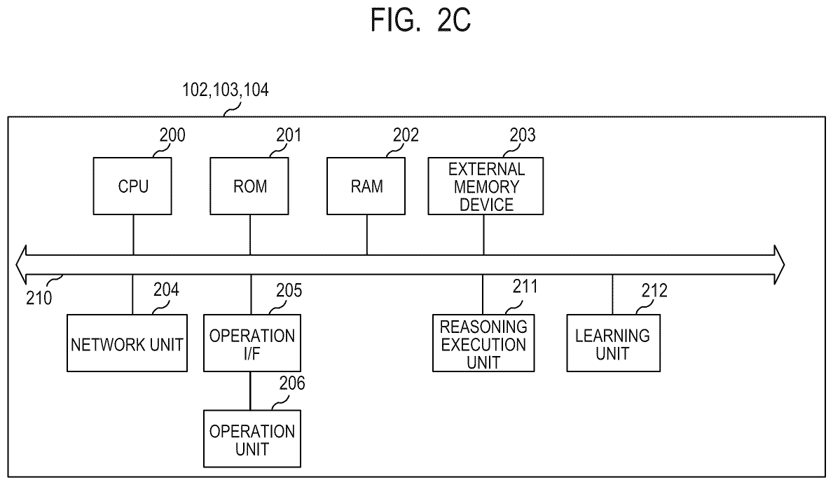

FIG. 2A is a block diagram showing an example of a general hardware configuration of the first device 106 and the second device 107 that may be used in one or more embodiments. The first device 106 and the second device 107 include Central Processing Unit (CPU) 200, Read Only Memory (ROM) 201, a Random Access Memory (RAM) 202, an external storage device 203, a network unit 204, an operation interface 205, an operation unit 206, a display interface 207, a display unit 208, a device controller 209, a system bus 210, a reasoning execution unit 211, and a learning unit 212.

The CPU 200 activates an operating system (OS) via a boot program stored in the ROM 201. The CPU 200 executes an application program stored in the external storage device 203 on the OS and performs various processes.

The RAM 202 is used as a work area of the CPU 200.

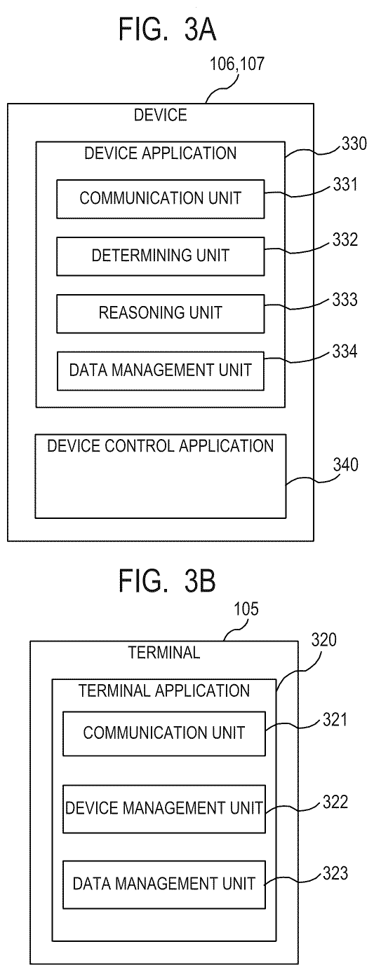

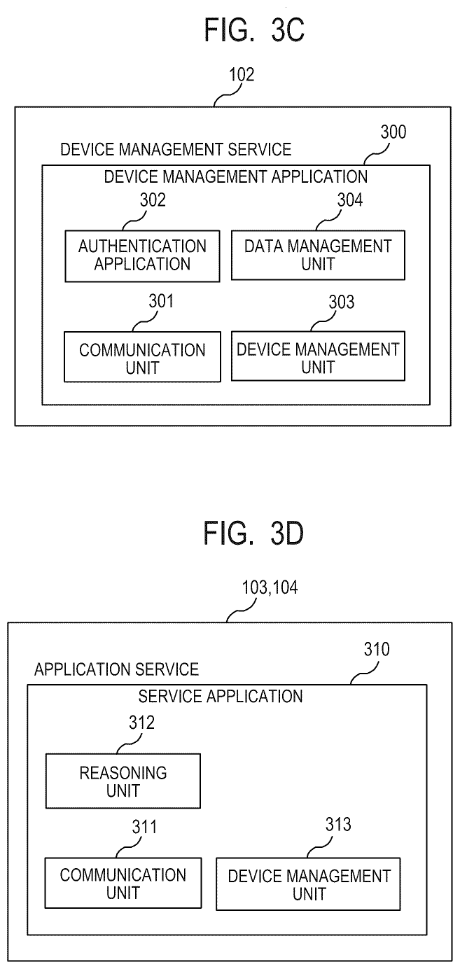

The external storage device 203 stores various programs such as a device application 330 and a device control application 340 shown in FIG. 3A, machine learning models used by the reasoning execution unit 211 and the learning unit 212, and various data including device settings and history information. The external storage device 203 may be a Hard Disk Drive (HDD) or a Solid State Drive (SSD).

The network unit 204 is connected to the network 100, and communicates with each component constituting the reasoning system of one or more embodiments.

The CPU 200 is connected to the ROM 201, the RAM 202, the external storage device 203, the network unit 204, the operation interface (I/F) 205, the display interface 207, the device controller 209, the reasoning execution unit 211, and the learning unit 212 via the system bus 210.

The operation interface 205 connects the operation unit 206 with the system bus 210.

The operation unit 206 transmits input data received from a user using an input device such as a keyboard, hardware keys, or a microphone to the CPU 200 via the operation interface 205.

The display interface 207 connects the display unit 208 with the system bus 100.

The display unit 208 may include a display and/or speakers. The display unit 208 outputs data sent from the CPU 200 via the display interface 207. The display unit 208 may also have the functions of the operation unit 206 like a touch panel. In a case where the display unit 208 includes a touch panel, the display unit 208 may be connected to both the operation interface 205 and the display interface 207.

The device controller 209 controls the operation of the device for each process performed by an application program that the CPU 200 executes. For example, it is assumed that the first device 106 is a microwave oven for at least one embodiment. In a case where the user selects a heating function, the CPU 200 transmits a control signal to components necessary for executing the heating function, specifically, a heater, a fan, a sensor, and the like, via the device controller 209.

The reasoning execution unit 211 executes reasoning processing in an application program executed by the CPU 200. The reasoning execution unit 211 may include a Neural Processing Unit (NPU) and/or a Graphics Processing Unit (GPU). The reasoning execution unit 211 is a component suitable for reasoning processing using a machine learning model. Depending on the scale of the machine learning model, the CPU 200 may perform reasoning processing instead of the reasoning execution unit 211.

The learning unit 212 acquires a result of the reasoning process executed by the reasoning execution unit 211. The learning unit 212 executes relearning processing of the machine learning model stored in the external storage device 203.

In the present embodiment, details of the reasoning processing and the relearning processing of the machine learning model are not described.

FIG. 2B is a block diagram showing an example of a general hardware configuration of the terminal 105 that may be used in one or more embodiments. The terminal 105 includes a CPU 200, a ROM 201, a RAM 202, an external storage device 203, a network unit 204, an operation interface 205, an operation unit 206, a display interface 207, a display unit 208, a system bus 210, a reasoning execution unit 211, and a learning unit 212. The basic components are same as those comprised or included in the first device 106 and the second device 107. Therefore, redundant descriptions are omitted. The external storage device 203 of the terminal 105 stores a program including a terminal application 320 shown in FIG. 3B instead of the device application 330 and the device control application 340.

In at least one embodiment, it is assumed that the terminal 105 is a mobile terminal such as a smartphone. However, the terminal 105 is not limited to a mobile terminal.

FIG. 2C is a block diagram showing an example of a general hardware configuration of the device management service 102, the first application service 103, and the second application service 104 that may be used in one or more embodiments. Each of the device management service 102, the first application service 103, and the second application service 104 includes a CPU 200, a ROM 201, a RAM 202, an external storage device 203, a network unit 204, an operation interface 205, an operation unit 206, a system bus 210, a reasoning execution unit 211, and a learning unit 212. Basic components are same as those comprised or included in the first device 106 and the second device 107. Therefore, redundant descriptions are omitted. The external storage device 203 of the device management service 102 stores a program including a device management application 300 shown in FIG. 3C instead of the device application 330 and the device control application 340. The external storage devices 203 of the first application service 103 and the second application service 104 store programs including a service application 310 shown in FIG. 3D instead of the device application 330 and the device control application 340.

The device management service 102, the first application service 103, and the second application service 104 exchange information with components constituting the reasoning system according to one or more embodiments through communications using the network 100. Therefore, each service does not necessarily require the display interface 207 and the display unit 208. The device management service 102, the first application service 103, and the second application service 104 may be realized by one computer or may be realized by multiple computers. The device management service 102, the first application service 103, and the second application service 104 may be cloud services implemented using the cloud computing technology.

FIGS. 3A, 3B, 3C, and 3D are block diagrams showing one or more embodiment examples of software configurations of each component that may be used for or with the reasoning system according to one or more aspects of the present disclosure. Hereinafter, FIGS. 3A, 3B, 3C, and 3D will be collectively referred to as “FIG. 3”. It should be noted that the block diagram shown in FIG. 3 shows software significantly related to one or more embodiments. For example, assume that the first device 106 is a microwave oven. The first device 106 actually includes software for realizing functions that may be performed by a microwave oven, such as a heating application and a blowing application. However, descriptions of the software for realizing the function specific to the microwave oven are omitted here.

The software configuration of one or more embodiments of the first device 106 and the second device 107 will be described with reference to FIG. 3A. The software configuration shown in FIG. 3A is realized by the CPU 200 reading and executing a program stored in any of the RAM 202, the ROM 201, and the external storage device 203 of the first device 106 and the second device 107 shown in FIG. 2A, respectively. Each of the first device 106 and the second device 107 has a device application 330 and a device control application 340.

The device application 330 has a function of executing a series of reasoning processes in the first device 106 and the second device 107. Hereafter, the operation of the first device 106 is mainly described, and the operation of the second device 107 is shown in parentheses.

The device application 330 includes a communication unit 331, a determining unit 332, a reasoning unit 333, and a data management unit 334. The communication unit 331 transmits and receives data to/from the terminal 105, the device management service 102, and the first application service 103 (or the second application service 104) via the network 100.

The determining unit 332 determines which of the first device 106 (or the second device 107), the first application service 103 (or the second application service 104), and the second device 107 (or the first device 106) should execute the reasoning process in response to a request (query data) of a user received from the terminal 105 on the basis of device registration information. The query data is transmitted via the operation unit 206 or the network unit 204 of the terminal 105. The device registration information is acquired from the terminal application 320 or the device management application 300 described later. In a case where it is determined that it is optimal to perform the reasoning process in the first device 106 (the second device 107), the determining unit 332 transmits a request for performing the reasoning process to the reasoning unit 333. In a case where it is determined that it is optimal to perform the reasoning process in the first application service 103 (or the second application service 104), the determining unit 332 transmits a request for performing the reasoning process to a reasoning unit 312 of the first application service 103 (or the second application service 104). In a case where it is determined that it is optimal to perform the reasoning process in the second device 107 (first device 106), the determining unit 332 transmits a request for performing the reasoning process to the reasoning unit 333 of the second device 107 (or the first device 106). The determining unit 332 receives a response of the user to a result of the reasoning process performed by any of the first device 106, the second device 107, and the first application service 103. The response from the user is transmitted via the operation unit 206 or the network unit 204 of the terminal 105. The determining unit 332 determines whether to continue the execution of the reasoning processing or to suspend the reasoning processing according to the response from the user.

The reasoning unit 333 performs reasoning processing using the AI technology. For example, the reasoning unit 333 performs reasoning processing using a machine learning model stored in the external storage device 203 of the device 106. The reasoning unit 333 displays a result of the reasoning process on the display unit 208.

The data management unit 334 manages setting information of the first device 106 and the second device 107. The data management unit 334 transmits and receives setting information between the terminal 105 and the device management service 102 via the network 100 and the network 101. A specific example of the setting information will be described later.

The device control application 340 is control software that operates in the device controller 209. The device control application 340 controls device functions. For example, in a case where the first device 106 or the second device 107 is a washing machine, the device control application 340 controls device functions necessary for performing a washing process. In a case where the first device 106 or the second device 107 is an air conditioning product, the device control application 340 controls functions necessary for adjusting the temperature and humidity of the room. In a case where the first device 106 or the second device 107 is an image forming apparatus, the device control application 340 controls functions necessary for executing print processing.

The software configuration of the terminal 105 will be described with reference to FIG. 3B. The software configuration shown in FIG. 3B is realized by the CPU 200 reading and executing an application program stored in any of the RAM 202, the ROM 201, and the external storage device 203 of the terminal 105 shown in FIG. 2B. The terminal 105 comprises a terminal application 320 including a communication unit 321, a device management unit 322, and a data management unit 323.

The terminal application 320 of the terminal 105 has a function of instructing the first device 106 (or the second device 107) to execute a series of reasoning processing. The terminal application 320 has a function of transmitting and receiving information of the first device 106 and the second device 107 to/from the device management service 102.

The communication unit 321 transmits and receives data to/from the first device 106, the second device 107, and the device management service 102 via the network 100 and the network 101.

The device management unit 322 searches, registers, and manages the first device 106 (or the second device 107) that is a communication target of the terminal 105. In a case of registering the first device 106 (or the second device 107), the device management unit 322 acquires user information about the owner of the first device 106 (or the second device 107) as authentication information. The user information is acquired from the user inputting information. The device management unit 322 transmits the user information to an authentication application 302 included in the device management application 300 of the device management service 102. If the authentication is successful, the device management unit 322 registers the information of the first device 106 (or the second device 107). The information of the registered first device 106 (or the second device 107) is managed by the data management unit 323. The device management unit 322 transmits device information managed by the data management unit 323 to the device management service 102 to share the information (data) with the device management service 102.

The software configuration of the device management service 102 will be described with reference to FIG. 3C. The software configuration shown in FIG. 3C is realized by the CPU 200 reading and executing an application program stored in any of the RAM 202, the ROM 201, and the external storage device 203 of the device management service 102 shown in FIG. 2C. The device management service 102 comprises a device management application 300 including a communication unit 301, an authentication application 302, a device management unit 303, and a data management unit 304.

The device management application 300 is an application program having a function for executing a series of device management processes in the device management service 102.

The communication unit 301 transmits and receives data to/from the terminal 105, the first device 106, and the second device 107 via the network 100 and the network 101.

The authentication application 302 identifies a user who owns the first device 106 (and/or the second device 107) and performs authentication processing. The user information of the first device 106 (and/or the second device 107) is managed by the data management unit 304.

The device management unit 303 associates the user authenticated by the authentication application 302 with information of the first device 106 (and/or the second device 107) owned by the user. The device management unit 303 registers and manages the associated information. In at least one embodiment, it is assumed that the registration process of the device information is executed by receiving data from the device management unit 322 of the terminal 105. However, the device information may be directly registered to the device management service 102 using a web browser or a dedicated application.

The data management unit 304 manages the user information and the device information used by the device management application 300.

The software configurations of the first application service 103 and the second application service 104 will be described with reference to FIG. 3D. The software configuration shown in FIG. 3D is realized by the CPU 200 reading and executing an application program stored in any of the RAM 202, the ROM 201, and the external storage device 203 of the first application service 103 and the second application service 104 shown in FIG. 2C. Each of the first application service 103 and the second application service 104 comprises a service application 310 including a communication unit 311, a reasoning unit 312, and a device management unit 313.

The service application 310 includes a function (the reasoning unit 312) of executing reasoning processing for the first device 106 and the second device 107. The service application 310 of the first application service 103 comprises a function of performing reasoning processing for the first device 106. The service application 310 of the second application service 104 comprises a function of performing reasoning processing for the second device 107.

The device management units 313 manage the device information of the first device 106 and the second device 107. The device management unit 313 of the first application service 103 manages device information of the first device 106. The device management unit 313 of the second application service 104 manages device information of the second device 107.

The communication unit 311 transmits and receives data to/from the first device 106, the second device 107, the terminal 105, and the device management service 102 via the network 100 and the network 101.

The reasoning unit 312 receives a request from the determining unit 332 of the device application 330. The reasoning unit 312 executes a reasoning process that is difficult for the first device 106 (or the second device 107) to execute. The reasoning processing that is difficult for the first device 106 (or the second device 107) to execute may be processing that takes a lot of time to complete the reasoning due to, for example, limitations of hardware performance that the first device 106 (or the second device 107) has. In general, the first application service 103 and the second application service 104 have higher hardware performance than the first device 106 and the second device 107.

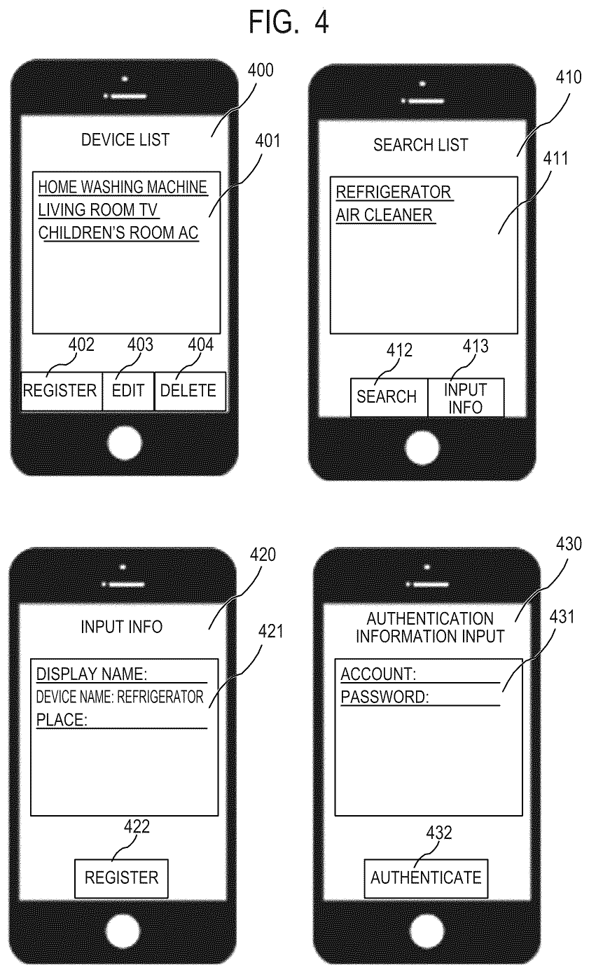

FIG. 4 shows a series of screens displayed on the display unit 208 of the terminal 105 in the device registration process that may be used in one or more embodiments.

### <Device List Screen 400>

On a device list screen 400, a list of device information registered in the terminal application 320 is displayed. The device list screen 400 includes a device list area 401, a device registration button 402, a device edit button 403, and a device delete button 404. The device list screen 400 is displayed, for example, in a case where the terminal application 320 is activated.

In the device list area 401, a list of device information registered to the terminal application 320 is displayed. In a case where the device information is not registered, the device list area 401 is blank. In one or more embodiments, the user may freely set a name of the device via the terminal application 320. For example, as shown in FIG. 4, a list of device names “Home Washing machine”, “Living Room TV”, and “Children's Room AC” input by the user may be displayed in the device list area 401.

The device registration button 402 is provided to shift the screen of the terminal 105 to a device search screen 410. In a case where the device registration button 402 is pressed, a series of device registration processing is started.

The device edit button 403 is provided to shift the screen of the terminal 105 to an information input screen 420. In a case where the device edit button 403 is pressed in a state where the device information displayed in the device list area 401 is selected, the screen of the terminal 105 transitions to the information input screen 420, and the user may edit the selected device information.

The device delete button 404 is provided to delete the registered device information. In a case where the user selects the device information displayed in the device list area 401 and then presses the device delete button 404, the selected device information is deleted. After deleting the device information, the device information is deleted from the device list area 401, and the device information registered in the device management unit 322 is also deleted.

### <Device Searching Screen 410>

The device search screen 410 is displayed in a case of searching devices connectable via the network 101.

In a case where the search button 412 is pressed, the terminal application 320 transmits a search request to all devices connected to the network 101 via the communication unit 321.

The terminal application 320 receives a list of results in response to the search request. The list of results is displayed on the device search screen 410.

The search list area 411 shows a list of device information found as a result of the search request. In one or more embodiments, the device information may include a name of a machine type, which is a fixed parameter for identifying the device, such as “refrigerator” or “air cleaner”. For example, in a case where two devices are found by the search, two names of machine types of the two devices found by the search is displayed in the search list area 411, as shown in FIG. 4.

The information input button 413 is provided to shift the screen of the terminal 105 to the information input screen 420. In a case where the user selects the device information displayed in the search list area 411 and then presses the information input button 413, the screen of the terminal 105 transitions to the information input screen 420. The user may input device information of the selected device through the information input screen 420.

### <Information Input Screen 420>

The information input screen 420 is displayed in a case of inputting additional information. The additional information helps the user of the device to easily identify the device registered to the terminal application 320. In a case where the device edit button 403 of the device list screen 400 is pressed, the screen of the terminal 105 also transitions to the information input screen 420.

The information input area 421 includes a display name field, a device name (machine type) field, and a place field.

The device name field displays a name of the machine type, which is a fixed parameter for identifying the device. As shown in FIG. 4, for example, “refrigerator” is displayed in the device name field.

The user may enter any character string in the display name field and the place field. The user may input in the display name field any character string corresponding to the name displayed in the device list screen 400. The user may enter in the location field any character string corresponding to the place where the device is installed. In the display name and location fields, the user may enter information that helps the user easily identify the registered device. The user may input information in the information input area 421 for facilitating the user to use the device via the terminal application 320. For example, information about the owner of the device may be input via the information input area 421.

The number of fields included in the information input area 421 is not limited to the description of FIG. 4. For example, the information input area 421 may be provided with additional fields for entering other information about the device.

The device registration button 422 is provided to shift the screen of the terminal 105 to the user authentication screen 430.

### <User Authentication Screen 430>

The user authentication screen 430 is displayed in a case where authentication processing is performed in the device management service 102. The authentication process is performed to confirm whether the user who owns the device has authority to use the service.

The user information area 431 includes an account field and a password field. An account (for example, a user name) is input in the account field. A password is input in the password field.

In a case where the authentication button 432 is pressed, the terminal application 320 transmits an authentication request to the device management service 102. The authentication request includes an account (e.g., a user name) entered in the account field of the user information area 431 and a password entered in the password field of the user information area 431. In response to receiving the authentication request, the device management service 102 performs authentication processing via the authentication application 302. If the authentication is successful, the terminal application 320 registers the device information input via the information input screen 420 in the device management unit 322. Then, the terminal application 320 causes the screen of the display unit 208 to transition to the device list screen 400. If the registration of the device is successful, the device display name input via the information input screen 420 is displayed in the device list area 401 of the device list screen 400.

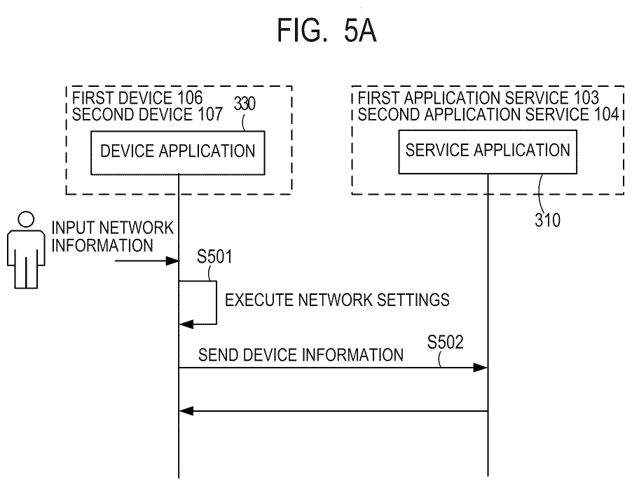

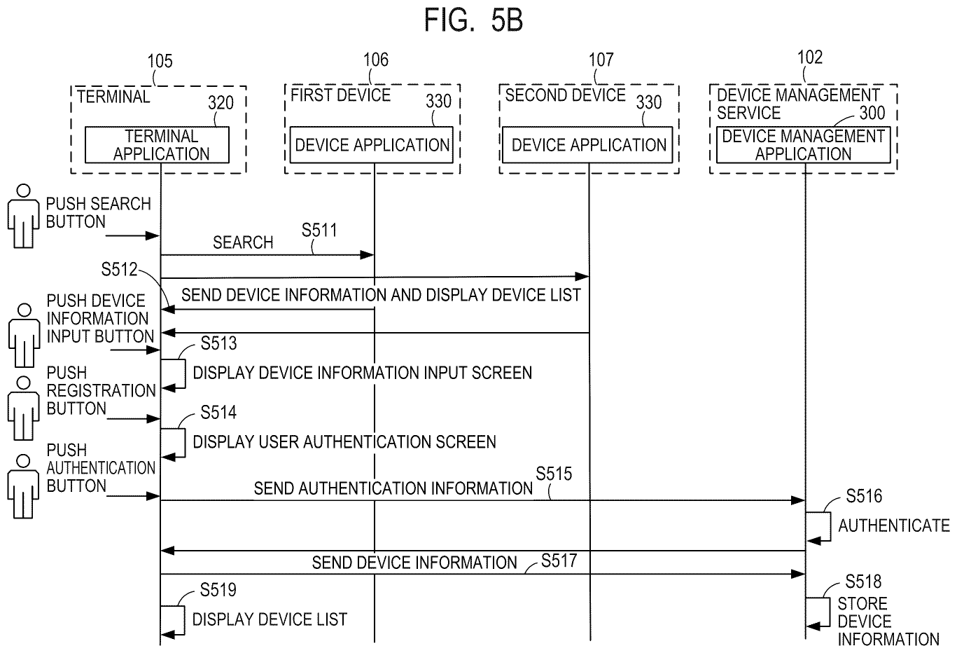

A sequence of the device registration process according to one or more embodiments will be described with reference to the sequence diagrams of FIG. 5A and FIG. 5B.

FIG. 5A shows at least one embodiment example of a sequence of registering the first device 106/the second device 107 to the first application service 103/the second application service 104.

In step S501, the user sets network information for the network unit 204 of the first device 106 or the second device 107 via the operation unit 206 of the first device 106 or the second device 107, for example. If the terminal 105 may be connected with the first device 106/the second device 107 via, for example, Bluetooth (registered trademark), the network information may be set for the network unit 204 of the first device 106/the second device 107 using the terminal 105. In a case where the setting of the network unit 204 is completed, the first device 106/the second device 107 are connected to the network 101 through the network unit 204. In a case where the network information is already set in the network unit 204, the first device 106 and the second device 107 are connected to the network 101 at the time of activation.

In step S502, the device application 330 of the first device 106/the second device 107 transmits the device information to the service application 310 of the first application service 103/the second application service 104.

Table 1 shows an example of the device information transmitted in step S502.

TABLE 1
Transmitted device information

| Serial | Machine Type | IP Address |
|---|---|---|
| W-11-AA | Washing Machine | XXX.XXX.XXX.XXX |

In Table 1, the column “Serial” indicates a serial number assigned to uniquely identify the device.

The column “Machine Type” indicates a name of machine type (i.e., a type of the device).

The column “IP Address” indicates an IP address that the device has.

The service application 310 that has received the device information registers the received device information to the device management unit 313.

Through the above steps, the sequence of registration processing between each device and each device application service is completed.

FIG. 5B shows an example of a sequence of processes for registering a device found as a result of the search using the terminal 105 to the device management service 102.

In a case of detecting a press of the device registration button 402 in the device list screen 400 displayed on the operation unit 206 (the display unit 208) of the terminal 105, the terminal application 320 of the terminal 105 displays the device search screen 410 on the display unit 208. In a case of detecting that the user presses the search button 412, the terminal application 320 advances the process to step S511.

In step S511, the terminal application 320 transmits a search request to all devices connected to the network 101.

In the sequence shown in FIG. 5B, search requests are transmitted to the first device 106 and the second device 107. As described above, however, the search request is actually transmitted to all the devices connected to the network 101.

In a case where the data management unit 334 of the device application 330 included in the first device 106/the second device 107 receives the search request transmitted in step S511, the process proceeds to step S512.

In step S512, the first device 106/the second device 107 acquires the device information managed by the data management unit 334, and transmits the acquired device information to the terminal application 320.

Table 2 shows an example of a search result transmitted from the data management unit 334 to the terminal application 320 as a response to the search request.

TABLE 2
Table of search result

| Serial | Machine Type | Service | IP Address |
|---|---|---|---|
| W-11-AA | Washing | First Application | XXX.XXX.XXX.XXX |
| | Machine | Service | |

In Table 2, the column “Serial” indicates a serial number assigned to uniquely identify the device.

The column “Machine Type” indicates a name of machine type (i.e., a type of the device).

The column “IP Address” indicates an IP address that the device has.

The column “Service” indicates the device application service to which the device has been registered in step S502.

Upon receiving the response including the device information, the terminal application 320 displays the received device information in the search list area 411 of the device search screen 410.

In a case where the user selects a desired device from the search list area 411 and presses the information input button 413, the terminal application 320 advances the process to step S513.

In step S513, the terminal application 320 displays the information input screen 420 and receives an input of additional device information. The input information about the display name and the place (installed location) is sent to the data management unit 323.

In a case where the user presses the device registration button 422, the terminal application 320 advances the process to step S514.

In step S514, the terminal application 320 displays the user authentication screen 430 and receives authentication information from the user.

In a case where the user presses the authentication button 432, the terminal application 320 advances the process to step S515.

In step S515, the terminal application 320 transmits the user authentication information input through the user authentication screen 430 to the authentication application 302.

Table 3 shows an example of authentication information transmitted from the terminal application 320 to the device management service 102.

TABLE 3
Table of authentication information

| Account | Password |
|---|---|
| UserA | XXXXXXXX |

The column “Account” indicates a user name. The account (user name) is issued in a case of making a contract with the first application service 103/the second application service 104. In one or more embodiments, the user “UserA” makes contracts with two application services, i.e., the first application service 103 and the second application service 104. However, the number of contracted services is not limited to two.

The column “password” indicates a password used in authentication processing.

Upon receiving the authentication information in step S515, the device management application 300 advances the process to step S516.

In step S516, the device management application 300 acquires the received authentication information of the user. The device management application 300 executes the authentication processing based on the authentication information via the authentication application 302, and notifies the terminal application 320 of a result of the authentication.

In a case where the result of the authentication in step S516 shows success, the terminal application 320 advances the process to step S517.

In step S517, the terminal application 320 transmits the device information selected on the device search screen 410 and the additional device information input on the information input screen 420 to the device management service 102.

Table 4 shows an example of the device registration information transmitted from the terminal application 320 to the device management service 102. The information shown in Table 4 is also data managed by the data management unit 323 of the terminal application 320.

TABLE 4
Table of device registration information

| | Machine | | Display | | IP | |
|---|---|---|---|---|---|---|
| Serial | Type | Service | Name | Place | Address | Account |
| W-11- | Washing | First | Home Washing | Washroom | XXX.XXX.XXX.XXX | UserA |
| AA | Machine | Application | Machine | | | |
| | | Service | | | | |

The column “Serial” indicates a serial number assigned to uniquely identify the device.

The column “Machine Type” indicates a name of machine type (i.e., a type of the device).

The column “Service” indicates the device application service to which the device has been registered in step S502.

The column “Display Name” and the column “Place” indicate the display name and place input by the user through the information input area 421.

The column “IP Address” indicates an IP address that the device has.

The column “Account” indicates an account of the contracted user associated with the device.

In a case where the device management application 300 receives the device information transmitted in step S517 via the communication unit 301, the process proceeds to step S518.

In step S518, the device management unit 303 of the device management application 300 stores the received device information in the data management unit 304.

In step S519, the device management unit 322 of the terminal application 320 stores in the data management unit 323 the device registration information transmitted to the device management service 102 in step S517. Then, the terminal application 320 displays the device list screen 400 on the display unit 208.

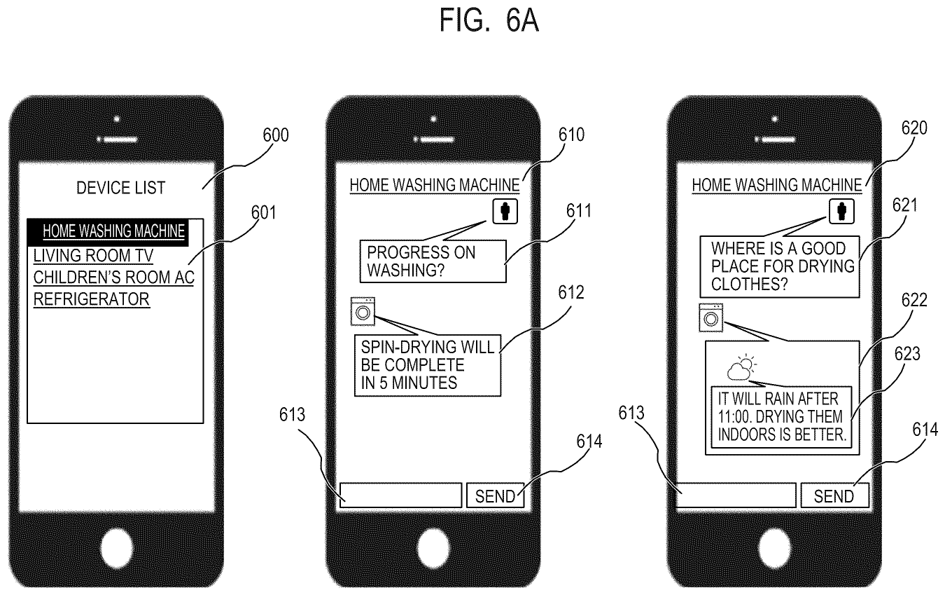

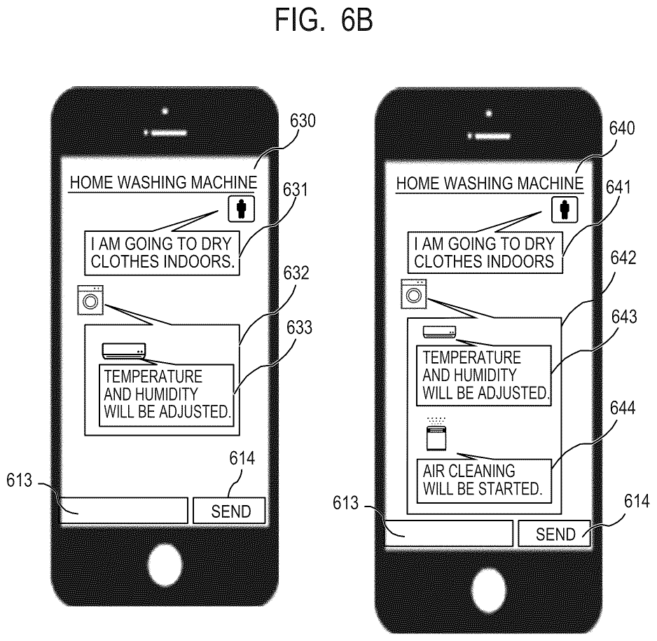

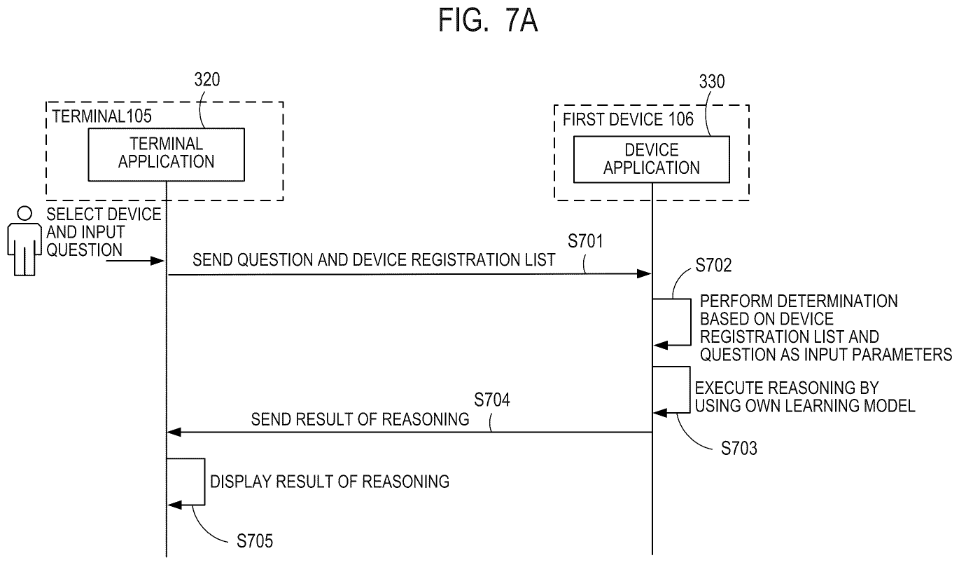

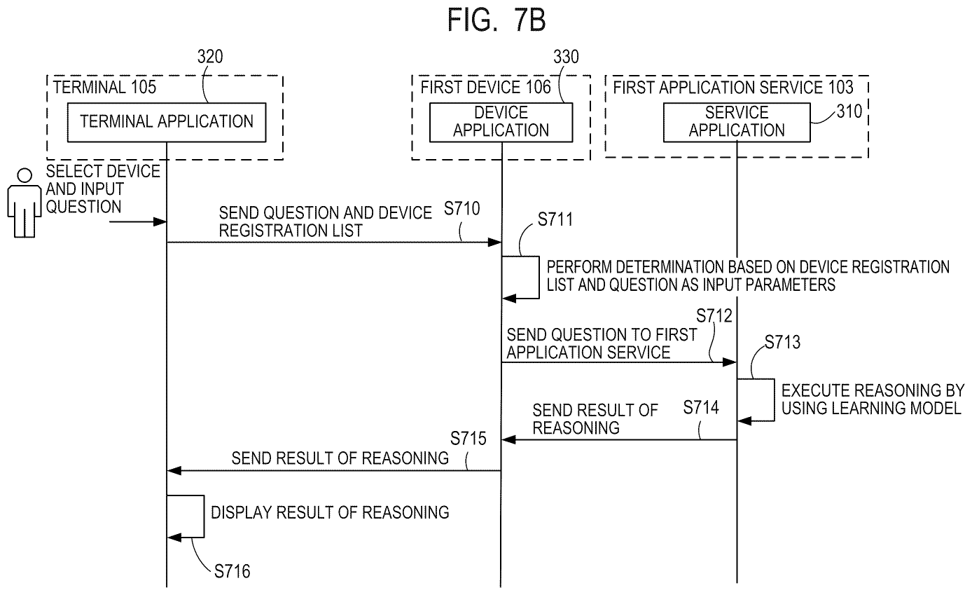

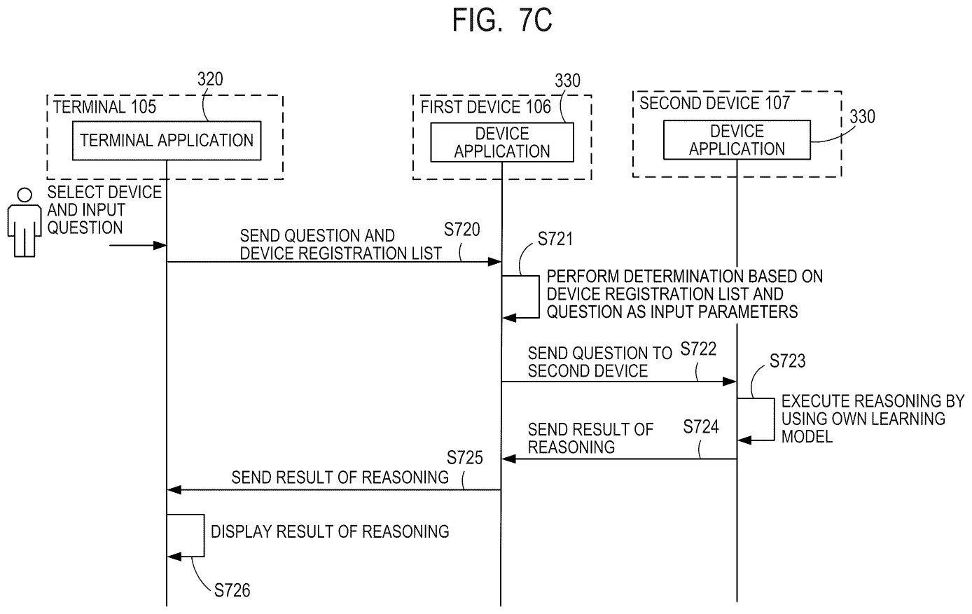

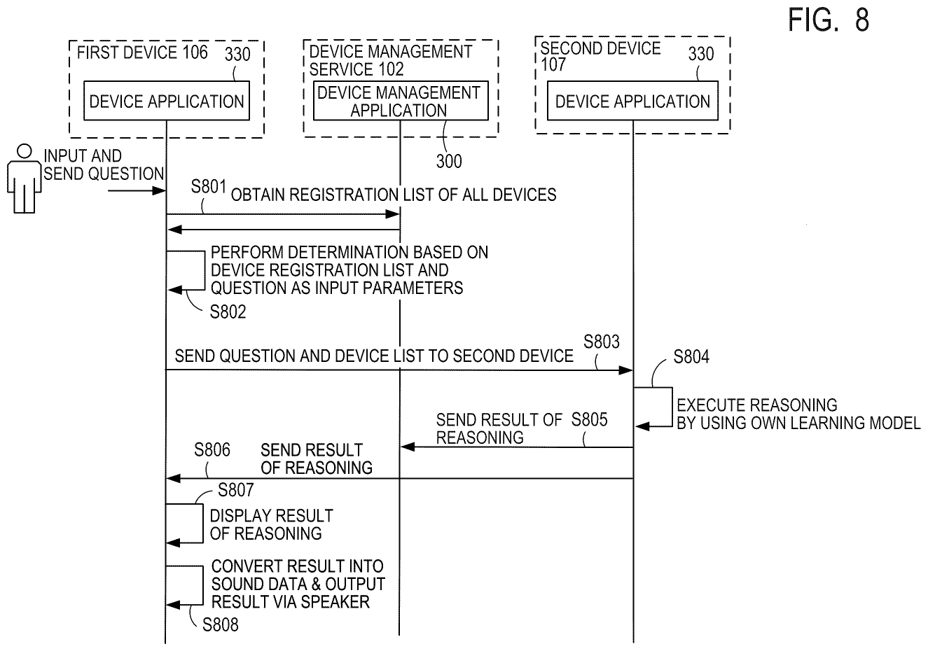

A series of reasoning processes according to one or more aspects of the present disclosure that may be used in one or more embodiments will be described with reference to FIG. 6A, FIG. 6B, FIG. 7A, FIG. 7B, FIG. 7C, and FIG. 8.

FIG. 6A and FIG. 6B are diagrams showing an example of a reasoning request and a reasoning result displayed on the display unit 208 of the terminal 105. Hereinafter, FIG. 6A and FIG. 6B will be collectively referred to as “FIG. 6”.

FIG. 7A, FIG. 7B, FIG. 7C, and FIG. 8 show examples of sequences of processes in which the determining unit 332 of the first device 106 according to one or more embodiments determines which reasoning unit performs the reasoning process and the reasoning unit indicated by the determination performs the reasoning process.

In FIG. 7A, FIG. 7B, and FIG. 7C, it is assumed that the terminal application 320 of the terminal 105 displays a screen shown in FIG. 6 on the display unit 208 of the terminal 105, and the first device 106 is selected and operated via the operation unit 206 of the terminal 105.

FIG. 8 shows a case where a question is input via the operation unit 206 of the first device 106 and a reasoning result is output to the display unit 208.

In the following description, the first device 106 is assumed to be a washing machine and the second device 107 is assumed to be an air conditioning product. However, the first device 106 and the second device 107 are not limited to a washing machine and an air conditioning product, respectively.

In FIG. 6, the device list screen 600 displays the first device 106 and the second device 107 managed by the device management unit 322 of the terminal application 320 in a list. In a case where the user selects a desired device from among the devices displayed in the device list area 601 on the device list screen 600, the device list screen 600 transitions to the reasoning request screen 610. Here, it is assumed that the first device 106 that is a “home washing machine” is selected.

The terminal application 320 displays the display name (in the example shown in FIG. 6A, “Home Washing Machine”) included in the device registration information (Table 4) on the upper portion of the reasoning request screen 610. The display name corresponds to the device (in this example, the first device 106) selected by the user in the device list screen 600. The device registration information is managed by the device management unit 322. The terminal application 320 receives a question input by the user through a question input area 613 provided in the lower portion of the reasoning request screen 610.

The sequence of processes shown in FIG. 7A is described below.

FIG. 7A shows a sequence of processes in which the determining unit 332 of the first device 106 determines where the reasoning process is performed and the first device 106 performs the reasoning process based on the determination.

The user inputs a question into the question input area 613 of the reasoning request screen 610, and presses a send button 614. In response to a press of the send button 614 by the user, the terminal application 320 displays the content input to the question input area 613 in a query area 611 of the reasoning request screen 610. The device management unit 322 of the terminal application 320 receives the information on the question input to the question input area 613 by the user. The device management unit 322 transmits the information about the question along with a list of the device registration information (Table 4) of all the devices managed by the data management unit 323 to the selected device (here, it is assumed that the first device 106 is selected) via the communication unit 321 (step S701).

The device application 330 of the first device 106 receives the list of the device registration information (Table 4) of all the devices and the information about the question via the communication unit 331, and the process proceeds to step S702. As described above, in at least one embodiment, the device application 330 receives a list of device registration information (Table 4) of all devices from the terminal application 320 along with information about the question. In at least another embodiment, in response to receiving information about a question (or periodically), a list of device registration information of all devices may be obtained from the device management application 300 of the device management service 102.

In step S702, the determining unit 332 of the device application 330 of the first device 106 inputs the question and the received list of device registrations (Table 4) of all the devices to the machine learning model as input parameters. Then, the determining unit 332 determines where to execute the reasoning process. In the example shown in FIG. 7A, it is assumed that the reasoning unit 333 of the first device 106 has been determined to perform reasoning processing.

In step S703, the reasoning unit 333 inputs information about the question to the machine learning model as an input parameter. Then, the reasoning unit 333 executes reasoning processing for the question. The machine learning model used by the reasoning unit 333 may be the same as the machine learning model used by the determining unit 332, or may be different from the machine learning model used by the determining unit 332.

In step S704, the reasoning unit 333 transmits a result of the reasoning to the terminal application 320, which is the input source of the query data, via the communication unit 331.

The terminal application 320 receives the result of the reasoning processing executed in step S704, and the process proceeds to step S705.

In step S705, the terminal application 320 displays the result of the received reasoning processing on the display unit 208. Specifically, the terminal application 320 presents, to the user via a reasoning result area 612 of the reasoning request screen 610, the result of the reasoning as an answer to the question displayed in the query area 611.

Next, the sequence shown in FIG. 7B is described below.

FIG. 7B shows a sequence of processes in a case where the determining unit 332 of the first device 106 determines where to perform the reasoning process and the first application service 103 associated with the first device 106 performs the reasoning processing based on the determination.

The user inputs a question in the question input area 613 of a reasoning request screen 620 and presses the send button 614. In response to a press of the send button 614 by the user, the terminal application 320 displays the question input to the question input area 613 in a query area 621 of the reasoning request screen 620. The device management unit 322 of the terminal application 320 receives information about a question input to the question input area 613 by the user. The device management unit 322 transmits the information about the question along with a list of the device registration information (Table 4) of all the devices managed by the data management unit 323 to the selected device (here, assumed to be the first device 106) via the communication unit 321 (step S710).

In a case where the communication unit 331 of the device application 330 of the first device 106 receives the device registration information (Table 4) list of all the devices and the information about the question, the process proceeds to step S711.

In step S711, the determining unit 332 of the device application 330 of the first device 106 inputs the information about the question and the received list of the device registration information (Table 4) of all the devices to the machine learning model as input parameters. Then, the determining unit 332 determines where to execute the reasoning process. In the example shown in FIG. 7B, it is assumed that the reasoning unit 312 of the first application service 103 is determined to perform the reasoning process.

In step S712, the terminal application 320 transmits the information about the question to the first application service 103.

The first application service 103 receives the information about the question transmitted in step S712, and the process proceeds to step S713.

In step S713, the reasoning unit 312 of the first application service 103 inputs the received information about the question to the machine learning model as an input parameter, and performs reasoning processing on the question.

In step S714, the reasoning unit 312 transmits a result of the reasoning obtained in step S713 to the device application 330 of the first device 106.

The device application 330 of the first device 106 receives the result of the reasoning transmitted in step S714, and the process proceeds to step S715.

In step S715, the determining unit 332 of the device application 330 transmits the result of the received reasoning process to the terminal application 320 that is the input source of the question.

The terminal application 320 receives the result of the reasoning transmitted in step S715, and the process proceeds to step S716.

In step S716, the terminal application 320 displays the result of the received reasoning on the display unit 208. Specifically, the terminal application 320 presents, to the user via a reasoning result area 622 of the reasoning request screen 620, a reasoning result 623 as an answer to the question shown in the query area 621.

Next, the sequence of processes shown in FIG. 7C will be described.

FIG. 7C shows a sequence of processes in which the determining unit 332 of the first device 106 determines where to perform the reasoning process, and the determining unit 332 determines that the second device 107 different from the first device 106 performs the reasoning process.

The user inputs a question in the question input area 613 of a reasoning request screen 630/640, and presses the send button 614. In a case where the send button 614 is pressed, the terminal application 320 displays in a question area 631/641 of the reasoning request screen 630/640 the question input in the question input area 613. The device management unit 322 of the terminal application 320 receives the information on the question input to the question input area 613 by the user. The device management unit 322 transmits the information about the question along with a list of the device registration information (Table 4) of all the devices managed by the data management unit 323 to the selected device (here, assumed to be the first device 106) via the communication unit 321 (step S720).

In a case where the communication unit 331 of the device application 330 of the first device 106 receives the list of the device registration information (Table 4) of all the devices and the information about the question, the process proceeds to step S721.

In step S721, the determining unit 332 of the device application 330 of the first device 106 inputs the received list of the device registration information (Table 4) of all the devices and the information about the question to the machine learning model as input parameters. Then, the determining unit 332 determines where to execute the reasoning process. Specifically, the determining unit 332 determines which device should execute the reasoning process based on the information about the question and the information of the “machine type” and “service” included in the list of the device registration information (Table 4) of all the devices. In the example shown in FIG. 7C, it is assumed that the reasoning unit 312 of the second device 107 is determined to perform reasoning.

There may be another device (referred to as a third device) connected to the same network to which the first device 106 and the second device 107 are also connected. As a result of the determination in step S721, both the second device 107 and the third device (i.e., multiple devices) may be requested to perform the reasoning processing.

In step S722, the terminal application 320 transmits information about the question to the second device 107. If the result of the determination in step S721 indicates that both the second device 107 and the third device are requested to perform reasoning, the terminal application 320 sends information about the question to the second device 107 and the third device.

In a case where the device application 330 of the second device 107 receives the information about the question in step S722, the process proceeds to step S723.

In step S723, the reasoning unit 333 of the second device 107 inputs information about the received question to the machine learning model as an input parameter, and performs a reasoning process on the question.

In step S724, the reasoning unit 333 of the second device 107 transmits a result of the reasoning obtained in step S723 to the device application 330 of the first device 106. The reasoning unit 333 of the second device 107 sends an instruction to the device control application 340 to perform a function of the second device 107 if the result of the reasoning includes performing the function. This instruction is processed by the device controller 209. In a case where the information about the question is also transmitted to the third device, the third device performs the same processes as steps S723 and S724.

In a case where the device application 330 of the first device 106 receives the result of the reasoning transmitted in step S724, the process proceeds to step S725.

In step S725, the determining unit 332 of the device application 330 transmits the result of the received reasoning to the terminal application 320 of the terminal 105 that is the input source of the query data. If the information about the question is transmitted to the third device receives, a result of the reasoning generated by the third device is also transmitted to the terminal application 320 of the terminal 105.

In a case where the terminal application 320 of the terminal 105 receives the result of the reasoning transmitted in step S725, the process proceeds to step S726.

In step S726, the terminal application 320 of the terminal 105 displays the result of the received reasoning on the display unit 208. Specifically, the terminal application 320 presents in a reasoning result area 632 of the reasoning request screen 630 a reasoning result 633 to the user as an answer to the question input to the question input area 613.

If both the second device 107 and the third device are requested to perform the reasoning as a result of the determination made in step S721, a reasoning result 643 and a reasoning result 644 are displayed in a reasoning result area 642 of the reasoning request screen 640 as an answer from the second device 107 and an answer from the third device to the question shown in the reasoning result input area 641.

In the examples shown in FIGS. 7A, 7B, and 7C, the terminal application 320 of the terminal 105 displays the screen shown in FIG. 6 on the display unit 208 of the terminal 105, and the user selects and operates the first device 106 via the operation unit 206 of the terminal 105. On the other hand, the screen shown in FIG. 6 may be displayed on the display unit 208 of the first device 106, and the first device 106 may be directly operated via the operation unit 206 of the first device 106.

FIG. 8 shows a sequence of processes in a case where the user inputs a question via the operation unit 206 of the first device 106 and the display unit 208 displays a result of the reasoning. In the sequence shown in FIG. 8, the determining unit 332 of the first device 106 determines where to execute the reasoning process and the second device 107 different from the first device 106 is determined to execute the reasoning process.

In a case where a question is input via the operation unit 206 of the first device 106, the device application 330 of the first device 106 advances the processing to step S801.

In step S801, the device application 330 acquires a list of device registration information (Table 4) of all devices from the device management application 300.

Steps S802 to S804 shown in FIG. 8 are the same as steps S721 to S723 shown in FIG. 7C, and thus descriptions thereof are omitted.

In step S805, the reasoning unit 333 of the second device 107 transmits a result of the reasoning obtained in step S804 to the device management application 300.

In step S806, the reasoning unit 333 of the second device 107 transmits the result of the reasoning obtained in step S804 to the device application 330 of the first device 106.

In a case where the device application 330 of the first device 106 receives the result of the reasoning obtained in step S804, the process proceeds to step S807.

In step S807, the device application 330 of the first device 106 displays the result of the received reasoning on the display unit 208 of the first device 106 from which the query data is input. If only the second device 107 is requested to perform reasoning processing, the screen displayed on the display unit 208 is the same as the reasoning request screen 630 shown in FIG. 6B. If both the second device 107 and the third device are requested to perform reasoning processing, the screen displayed on the display unit 208 is similar to the reasoning request screen 640 shown in FIG. 6B.

If the first device 106 includes an audio output mechanism, in step S808, the device application 330 of the first device 106 converts the received result of the reasoning processing into audio data, and provides the result of the reasoning as audio output for the users.

Another sequence of processes is described below. In the present sequence (no figure is shown), a question is input via the operation unit 206 of the first device 106, reasoning processing is performed using the first device 106 as a result of the determination (see FIG. 7A), and a reasoning result is output to the display unit 208. Instead of executing step S803 to step S807 shown in FIG. 8, the reasoning unit 333 of the first device 106 performs reasoning processing, and then a result of the reasoning is displayed on the operation unit 206 (display unit 208) of the first device 106.

In addition, further another sequence of processes is described below. In the present sequence (no figure is shown), a question is input via the operation unit 206 of the first device 106, reasoning processing is performed using the first application service 103 related to the first device 106 as a result of the determination (see FIG. 7B), and a reasoning result is output to the display unit 208. Instead of performing step S803 to step S806, the first device 106 transmits information about the question to the first application service 103, and then the reasoning unit 312 of the first application service 103 performs reasoning processing, and then the first device 106 receives a reasoning result from the first application service 103.

Through the above-described series of processes, it is determined which a device or a cloud service has an optimal machine learning model for reasoning processing. If it is determined that reasoning is to be performed using another device, the reasoning is executed by directly requesting the device. As a result, the user may have a reasoning result obtained using the machine learning model in which the personality of the user is more reliably reflected, and the performance of the response may be improved.

The functions of the determining unit 332 in one or more of the embodiments need not be provided in all devices, and may be provided in at least one device. For example, the first device 106 is provided with the functions of the determining unit 332, but the second device 107 may not be provided with the functions of the determining unit 332.

In a case where a smart speaker is used as the terminal 105, input of query data is performed through voice, and answer data (data corresponding to answers) to the query are output through voice.

### Configuration(s) for One or More Additional Embodiments

In the example shown in one or more embodiments, the first device 106 or the second device 107 determines where to perform the reasoning, as shown in FIG. 7C. If another device (third device) is connected to the same network and the determining unit 332 determines that the two devices should perform the reasoning, the two devices perform the reasoning.

If the second device 107 is of the same machine type as the third device and has comparable performance, it may not be necessary to perform the reasoning using the two devices, and it may be sufficient that either device performs the reasoning. In this case, the level of accuracy of the machine learning model is used to determine which device should perform the reasoning, and a request for the reasoning is sent to the device determined to have higher accuracy of the machine learning model.

Data management and processing for realizing the above configuration will be described in detail below.

First, management of model accuracy values is described below.

Table 5 shows an example of a search result as a response to a search request from the terminal application 320 according to one or more additional embodiments. The search result shown in Table 5 is transmitted by the data management unit 334 of the device application 330.

TABLE 5
Table of search result

| | Machine | | | Model |
|---|---|---|---|---|
| Serial | Type | Service | IP Address | Accuracy |
| W-11- | Washing | First Application | XXX.XXX.XXX.XXX | 0.8 |
| AA | Machine | Service | | |

The columns other than the model accuracy are the same as the columns shown in Table 2, and thus detailed descriptions thereof are omitted.

The model accuracy is a value representing the accuracy of the model. It is determined that the closer the value of model accuracy is to 1, the better the accuracy of the model is.

Table 6 shows an example of data managed by the device management unit 322 of the terminal application 320. These data are also an example of a list of device registration information of all devices that are sent along with information about the questions in a case where requesting the reasoning processing.

The device management unit 322 of the terminal application 320 periodically acquires the latest device registration information from the device management service 102, and updates the data managed by the device management unit 322 using the acquired data.

TABLE 6
Table of device registration information

| | Machine | | Display | | IP | | Model |
|---|---|---|---|---|---|---|---|
| Serial | Type | Service | Name | Place | Address | Account | Accuracy |
| W-11- | Washing | First | Home | Washroom | XXX.XXX.XXX.XXX | UserA | 0.8 |
| AA | Machine | Application | Washing | | | | |
| | | Service | Machine | | | | |

The columns other than the column of the model accuracy are the same as the respective columns shown in Table 4, and the column of the model accuracy is the same as the column of the model accuracy shown in Table 5. Thus, detailed descriptions thereof are omitted.

The device management unit 322 of the terminal application 320 manages values of the model accuracy using the table shown in Table 6.

The data shown in Table 6 is used to perform the processing described below for selecting a single device to perform reasoning processing.

The determining unit 332 of the terminal application 320 determines a device to perform the reasoning processing in step S721 of FIG. 7C, for example. In step S721, in a case where the determining unit 332 determines that there are multiple devices categorized as the same machine type and that reasoning should be performed by a single device, the determining unit 332 selects a device having the highest model accuracy among the devices included in the list of the device registration information (Table 6) of all the devices transmitted from the terminal application 320 as the device to perform the reasoning processing.

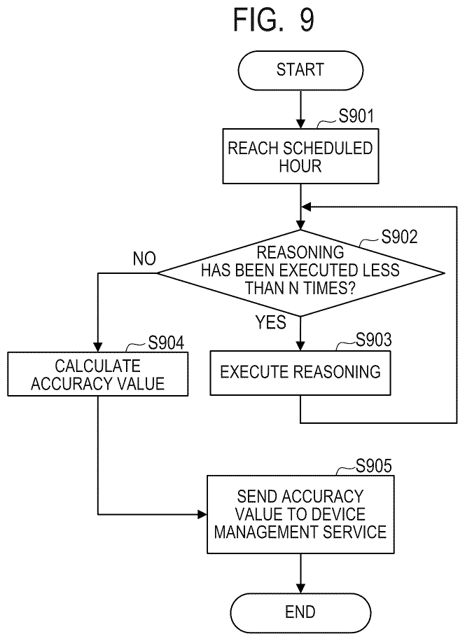

FIG. 9 depicts a flowchart showing an example of processes according to one or more additional embodiments in which the determining unit 332 of the device application 330 operating in each of the first device 106 and the second device 107 periodically measures the accuracy of the machine learning model and transmits the model accuracy to the device management service 102. The processing shown in FIG. 9 is realized by the CPU 200 of each of the first device 106 and the second device 107 executing a program stored in the external storage device 203.

In step S901, the determining unit 332 of the device application 330 determines that a predetermined periodic time has been reached, and the process proceeds to step S902.

In step S902, the determining unit 332 determines whether the number of times the reasoning process has been performed is less than a predetermined number of times N.

If the number of the executions is less than N (Yes in step S902), the determining unit 332 advances the process to step S903.

In step S903, each determining unit 332 of the first device 106 and the second device 107 performs the reasoning process, and the process returns to step S902.

In a case where the number of times the reasoning process has been performed reaches the predetermined number of times N (No in step S902), the determining unit 332 advances the process to step S904. That is, the determining unit 332 repeatedly executes the reasoning process a specific number (N) of times. The same question is used in each reasoning process.

In step S904, the determining unit 332 calculates a rate of the correct answer obtained from the reasoning process repeatedly performed on the same question. The calculated rate of the correct answer is regarded as a level of model accuracy, and the process proceeds to step S905.

In step S905, the determining unit 332 transmits a value of the model accuracy calculated in step S904 to the device management service 102 via the communication unit 331.

The device management unit 303 of the device management service 102 receives the value of model accuracy transmitted in step S905, and manages the value of model accuracy in the data management unit 304.

In a case where the query data is input (or periodically), the determining unit 332 of each device 106, 107 acquires the device information of each device including the model accuracy from the device management service 102. The determining unit 332 uses the acquired device information in a case where it is determining which device performs reasoning processing for query data. In a case where each device 106, 107 receives the device information of each device including the model accuracy along with the query data from the client terminal 105, the determining unit 332 may use the received device information for the determination. In this case, the client terminal 105 acquires the device information of each device from the device management service 102 periodically or before transmitting the query data to the devices. The client terminal 105 may collect device information including model accuracy from each device.

In a case where it is determined that there are multiple devices connected in the network, having the same performance, and categorized as the same machine type, and it is also determined that the first device should solely perform reasoning processing, the determining unit 332 of the device determines to transmit a reasoning request to a device having the highest mode accuracy based on the acquired values representing the model accuracy. According to this configuration, a reasoning result may be obtained without performing wasteful processing.

According to one or more embodiments, the user may obtain a reasoning result using the machine learning model in which the personality of the user is more reliably reflected. In addition, the response performance may be improved. That is, coordinating multiple edge devices having a reasoning function using artificial intelligence without deteriorating the performance of response allows users to efficiently obtain a result of reasoning processing.

Note that the configurations and specific contents of the various kinds of data described above are not specifically limited to those shown in any particular embodiment, and they may be changed or modified according to various applications or purposes.

In addition to the one or more embodiments or the one or more additional embodiments, the present disclosure also includes embodiments as, for example, a system, an apparatus, a method, a program, or a storage medium. Specifically, the techniques described in the present disclosure may be applied to a system including multiple devices, or the techniques described in the present disclosure may be applied to equipment including a single device.

In addition, a configuration in which the above embodiments are combined is also included in the present disclosure.

### One or More Other Embodiments

Embodiment(s) of the present disclosure may also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, coordinating multiple edge devices having a reasoning function using artificial intelligence without deteriorating the performance of response allows users to efficiently obtain a result of reasoning processing.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-186365, filed Oct. 23, 2024, which is hereby incorporated by reference herein in its entirety.

What is claimed is:

1. A system comprising a plurality of edge devices, each of the plurality of edge devices including:
an operating unit that receives operations from a user;
a communicating unit that connects the edge device to a network; and
a reasoning unit that performs a reasoning process by using a machine learning model for generating answer data as a response to query data,
wherein a first edge device of the plurality of edge devices includes:
a determining unit that determines which of the reasoning unit, a second edge device and a service should perform the reasoning process to query data in a case where the query data is input from a client terminal communicable via the network or the operating unit, the second edge device being different from the first edge device and the service providing a reasoning function via the network for the first edge device;
a transmitting unit that transmits the query data to the second edge device without passing through the service in a case where it is determined that the second edge device should perform the reasoning process; and
a displaying unit that displays answer data as a response to the query data for the user via the operating unit or the client terminal being a source of the input query data, the query data having been reasoning-processed by the second edge device, and the answer data having been received from the second edge device, and
wherein the second edge device includes:
a reasoning unit that performs the reasoning process for generating answer data as a response to query data in a case where the query data is received from another edge device than the second edge device; and
a responding unit that responds to the another edge device with the answer data.

2. The system according to claim 1, further comprising a management service that manages information of each of the plurality of edge devices,
wherein the first edge device further includes an acquiring unit that acquires information of each of the plurality of edge devices from the management service, and
wherein the determining unit uses the acquired information of each of the plurality of edge devices for the determination.

3. The system according to claim 2,
wherein the information of each of the plurality of edge devices includes information of accuracy of the reasoning process performed by the reasoning unit comprised of each of the plurality of edge devices,
wherein the information of the accuracy of the reasoning process is generated based on a result of the reasoning process performed by using the reasoning unit comprised of each of the plurality of edge devices, the reasoning process being periodically performed by each of the plurality of edge devices, and the generated information of the accuracy of the reasoning process being registered to the management service, and
wherein, in a case where it is determined that the second edge devices should perform the reasoning process, the determining unit determines based on the information of the accuracy of the reasoning process that an edge device having a higher accuracy of the reasoning process among the second edge devices should perform the reasoning process.

4. The system according to claim 1, wherein, in a case where information of each of the plurality of edge devices is received from the client terminal, the determining unit uses the received information of each of the plurality of edge devices for the determination.

5. The system according to claim 4,
wherein the information of each of the plurality of edge devices includes information of accuracy of the reasoning process performed by the reasoning unit comprised of each of the plurality of edge devices,
wherein, in a case where determined that the second edge devices should perform the reasoning process, the determining unit determines based on the information of the accuracy of the reasoning process that an edge device having a higher accuracy of the reasoning process among the second edge devices should perform the reasoning process, and
wherein the information of the accuracy of the reasoning process is based on a result of the reasoning process performed by using the reasoning unit comprised of each of the edge devices, the reasoning process being periodically performed by each of the plurality of edge devices.

6. The system according to claim 1, wherein the plurality of edge devices is at least one of a home electrical appliance and office machinery.

7. An edge device comprising:
an operating unit that receives operations from a user;
a communicating unit that connects the edge device to a network;
a reasoning unit that performs a reasoning process by using a machine learning model for generating answer data as a response to query data;
a determining unit that determines which of the reasoning unit, a second edge device, and a service should perform the reasoning process to query data in a case where the query data is input from a client terminal communicable via the network or the operating unit, the second edge device being communicable with the edge device and the service providing a reasoning function via the network for the edge device;
a transmitting unit that transmits the query data to the second edge device without passing through the service in a case where it is determined that the second edge device should perform the reasoning process; and
a displaying unit that displays answer data as a response to the query data for the user via the operating unit or the client terminal being a source of the input query data, the query data having been reasoning-processed by the second edge device, and the answer data having been received from the second edge device.

8. The edge device according to claim 7, further comprising an acquiring unit that acquires information of each of the edge devices from a management service that manages information of the edge device and the second edge device,
wherein the determining unit uses the acquired information of the edge devices for the determination.

9. The edge device according to claim 8,
wherein the information of each of the edge devices includes information of accuracy of the reasoning process performed by each of the edge devices,
wherein the information of the accuracy of the reasoning process is generated based on a result of the reasoning process performed by using the reasoning unit comprised of each of the edge devices, the reasoning process being periodically performed by each of the edge devices, and the generated information of the accuracy of the reasoning process being registered to the management service, and
wherein, in a case where it is determined that the second edge devices should perform the reasoning process, the determining unit determines based on the information of the accuracy of the reasoning process that an edge device having a higher accuracy of the reasoning process among the second edge devices should perform the reasoning process.

10. The edge device according to claim 7, wherein, in a case where information of each of the edge devices is received from the client terminal, the determining unit uses the received information of each of the edge devices for the determination.

11. The edge device according to claim 10,
wherein the information of each of the edge devices includes information of accuracy of the reasoning process performed by each of the edge devices,
wherein, in a case where it is determined that the second edge devices should perform the reasoning process, the determining unit determines based on the information of the accuracy of the reasoning process that an edge device having a higher accuracy of the reasoning process among the second edge devices should perform the reasoning process, and
wherein the information of the accuracy of the reasoning process is based on a result of the reasoning process performed by each of the edge devices, the reasoning process being periodically performed by each of the edge devices.

12. The edge device according to claim 7, wherein the edge devices are at least one of a home electrical appliance and office machinery.

13. A method of controlling a system comprising a plurality of edge devices, each of the plurality of edge devices including an operating unit that receives operations from a user, a communicating unit that connects the edge device to a network, and a reasoning unit that performs a reasoning process by using a machine learning model for generating answer data as a response to query data, the method comprising:
determining, in a first edge device of the plurality of edge devices, which of the reasoning unit, a second edge device and a service should perform the reasoning process to query data in a case where the query data is input from a client terminal communicable via the network or the operating unit, the second edge device being different from the first edge device and the service providing a reasoning function via the network for the first edge device;
transmitting, from the first edge device, the query data to the second edge device without passing through the service in a case where it is determined that the second edge device should perform the reasoning process;
displaying, on the first edge device, answer data as a response to the query data for the user via the operating unit or the client terminal being a source of the input query data, the query data having been reasoning-processed by the second edge device, and the answer data having been received from the second edge device;
performing, in the second edge device, the reasoning process for generating answer data as a response to query data by using the reasoning unit comprised of the second edge device in a case where the query data is received from another edge device than the second edge device; and
responding, from the second edge device, to the another edge device with the answer data.

14. A method of controlling an edge device including an operating unit that receives operations from a user, a communicating unit that connects the edge device to a network, and a reasoning unit that performs a reasoning process by using a machine learning model for generating answer data as a response to query data, the method comprising:
determining which of the reasoning unit, a second edge device and a service should perform the reasoning process to query data in a case where the query data is input from a client terminal communicable via the network or the operating unit, the second edge device being communicable with the edge device and the service providing a reasoning function via the network for the edge device;
transmitting the query data to the second edge device without passing through the service in a case where it is determined that the second edge device should perform the reasoning process; and
displaying answer data as a response to the query data for the user via the operating unit or the client terminal being a source of the input query data, the query data having been reasoning-processed by the second edge device, and the answer data having been received from the second edge device.
